(19) United States
(12) Patent Application Publication
(10) Pub. No.: US 2007/0237100 A1
(43) Pub. Date: Oct. 11, 2007

(54) DEVICE FOR PROCESSING DATA TO BE TRANSMITTED ON A RETURN CHANNEL OF A COMMUNICATION NETWORK AND NOT NECESSITATING SYSTEMATIC ACKNOWLEDGEMENT ON A GO CHANNEL

(75) Inventor: Beatrice MARTIN, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/696,673

(22) Filed: Apr. 4, 2007

(30) Foreign Application Priority Data
Apr. 5, 2006 (EP) 06300328.9

(51) Int. Cl. H04B 7/005; H04Q 7/00

(52) U.S. Cl. 370/278; 370/329

(57) ABSTRACT

A processor device (D) is intended to be installed in a radio communication terminal (UE) adapted to be connected to a radio communication network having a go channel for broadcasting data from said network to terminals (UE) and a return channel dedicated to transmitting data from the terminals (UE) to said network, characterized in that it comprises processor means (MT) adapted to extract from control messages broadcast by said network on the go channel parameters for access to said return channel and to generate data messages to be transmitted to said network on said return channel as a function of said access parameters and not necessitating systematic acknowledgement on said go channel.

The invention concerns radio communication networks that use a first band of frequencies or first time slots to broadcast data by radio on a go channel to radio communication terminals and a second band of frequencies or second time slots to enable those radio communication terminals to transmit data on a return channel.

Here “radio communication network” means any type of network having a radio access network capable of broadcasting data. It may in particular be a satellite network, such as an SDMB (standing for “Satellite Digital Multimedia Broadcast”) network, for example, or a terrestrial radio network, such as a UMTS network adapted for broadcasting, for example (of the MBMS (standing for “Multimedia Broadcast/Multicast Services”) or DVB-H (standing for “Digital Video Broadcasting—Handhelds”—mobile television—type) for example), or a hybrid (satellite plus terrestrial network).

Moreover, “go channel” here means the channel used in particular to broadcast data from the network to the terminals (also called the downlink in the case of a terrestrial network) and “return channel” here means the channel enabling terminals to transmit data to the network (also called the uplink in the case of a terrestrial network).

Moreover, “radio communication terminal” here means any fixed or mobile (or portable or cellular) communication equipment capable of exchanging data by radio with another equipment via a radio access network. Consequently, it may be a question, for example, of a fixed or mobile (or cellular) telephone, a fixed or portable computer, or a personal digital assistant (PDA), provided that it is equipped with radio communication means, where appropriate of satellite type, adapted to receive broadcast data.

In the networks cited above, the terminals can use a return channel to transmit data. However, this necessitates either the provision of dedicated point-to-point type connections or acknowledgement of the reception of data by the network, and thus the implementation of dedicated signaling on the go channel. This dedicated signaling consumes a portion of the radio capacity (or bandwidth) of the broadcast go channel, thus reducing the broadcasting capacity of the network. Now, reducing this broadcasting capacity leads to a reduction of the economic benefit of the broadcasting infrastructure of a network.

It is undoubtedly possible for terminals to transmit certain types of data message to a broadcast network without this necessitating an acknowledgement. This is the case in SDMB type satellite networks, for example, in the case of messages intended to transmit presence tokens for effecting audience measurements or emergency messages or location messages. However, these particular messages must be transmitted by the terminals to a terrestrial radio access network which then assumes responsibility for transmitting them to the SDMB network. This is what is called an “interactive terrestrial channel”. The drawback of this technique lies in the fact that the terminals can transmit their data messages only on condition that they are situated in the coverage area of a terrestrial radio access network, which is not always the case, in particular in the absence of local terrestrial coverage or if the terrestrial radio access network is unavailable, for example because of an overload.

No known solution proving entirely satisfactory, an object of the invention is therefore to improve upon the situation.

To this end it proposes a processor device intended to be installed in a radio communication terminal adapted to be connected to a radio communication network having go and return channels (as defined in the introductory portion) for radio communications. The go and return channels respectively correspond to separate first and second bands of frequencies or separate time slots or sets of time slots (for example in the case of the TDD (Time Division Duplex) transmission mode which uses a single carrier divided into time slots selectively assigned to the go and return channels).

This processor device is characterized in that it comprises processor means responsible for extracting from control messages broadcast by the network on the go channel parameters for access to the return channel and generating data messages to be transmitted to the network on the return channel as a function of the access parameters and not necessitating systematic acknowledgement on the go channel.

Here “not necessitating systematic acknowledgement” means necessitating an acknowledgement if and only if that is expressly requested in the message itself. Consequently, if there is no acknowledgement request, the message is never acknowledged.

The device according to the invention may have other features and in particular, separately or in combination:
its processor means may be responsible for integrating into some of the messages auxiliary data representing a request for acknowledgement by the network on its go channel;
its processor means may be responsible for analyzing the data to be transmitted in the form of a message to determine its priority level and to decide to integrate this auxiliary data into a message containing the analyzed data as a function of its priority level;
its processor means may be responsible for splitting data to be transmitted into at least two data groups and to integrate these groups into different messages;
the data messages to be transmitted may be short type messages (for example SMS messages) adapted not to necessitate systematic acknowledgement on the go channel, for example;
in a first embodiment the data messages to be transmitted may be “measurement report” type messages comprising the data to be transmitted, for example, replacing or added to the measurements effected by the terminal;
in a second embodiment the data messages to be transmitted may be “internal event report” type messages comprising the data to be transmitted, for example, replacing or added to data representing an event that has occurred in the terminal;
its processor means may be responsible for integrating the data to be transmitted into a content field of a measurement or internal event report message;
its processor means may be responsible for ordering the transmission of the data messages at frequencies or in time slots that are a function of their type and/or the requirement for acknowledgement.

The invention also proposes a radio communication terminal equipped with a processor device of the type described hereinabove.

The invention also proposes a radio communication network comprising first communication means responsible for broadcasting data by radio on a go channel and second communication means responsible for receiving data transmitted by radio communication terminals by radio on a return channel.

This network is characterized in that its first communication means are responsible for generating and broadcasting on the go channel control messages to the terminals including parameters defining access to the return channel and its second communication means are responsible, in the case of reception on the return channel of messages generated by the terminals by means of a processor device of the above type, for analyzing each message to determine if it requires an acknowledgement on the go channel and to order the first communication means to generate an acknowledgement message to the terminal concerned if such an acknowledgement is required.

The network according to the invention may have other features and in particular, separately or in combination:
its second communication means may be responsible, in the case of reception on the return channel of messages including data groups resulting from splitting of initial data by a processor device of a terminal, for re-assembling these groups in an ordered manner to reconstitute the initial data;
its second communication means may be responsible for analyzing the content of each message to determine if it requires an acknowledgement;
alternatively, its second communication may be responsible for determining if a message requires an acknowledgement as a function of the time slot in which it was transmitted or the frequency on which it was transmitted;
its second communication means may be responsible for ordering the transmission of an acknowledgement if the available capacities on the go channel enable such transmission;
its second communication means may be responsible for ordering the deferred transmission of an acknowledgement if the available capacities on the go channel do not enable such transmission immediately;
the first communication means and the second communication means are at least in part installed in base stations responsible for analyzing the content of each message generated by a terminal by means of its processor device, for example.

Other features and advantages of the invention will become apparent on reading the following detailed description and examining the appended drawings, in which:

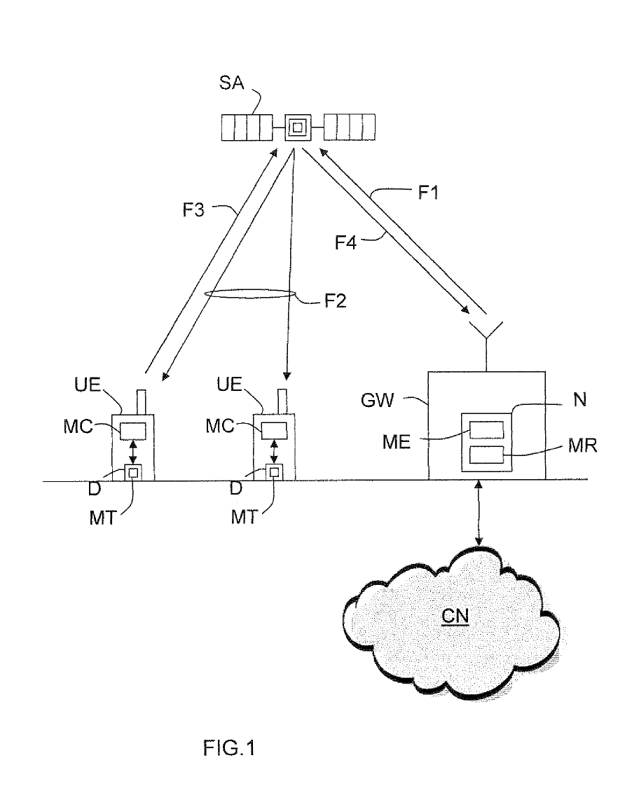

FIG. 1 is a functional diagram of a portion of a satellite broadcasting network according to the invention and of terminals equipped with one embodiment of a processor device according to the invention, and

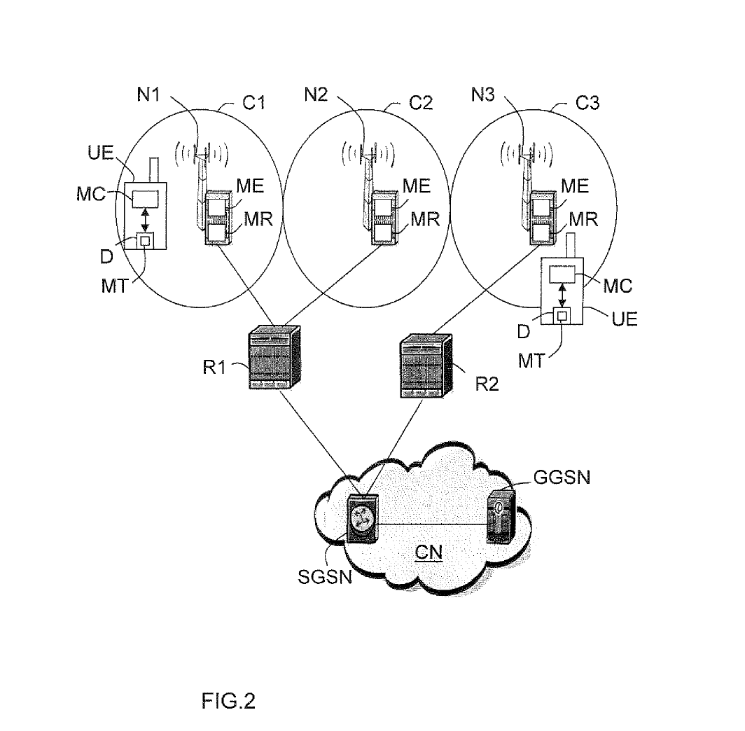

FIG. 2 is a functional diagram of a portion of a terrestrial broadcasting network according to the invention and of mobile terminals equipped with one embodiment of a processor device according to the invention.

The appended drawings constitute part of the description of the invention as well as contributing to the definition of the invention, if necessary.

An object of the invention is to enable radio communication terminals to transmit data messages on a return channel of a radio communication network the go channel whereof is primarily dedicated to broadcasting data, where applicable of multimedia type.

It is considered hereinafter by way of nonlimiting example that the communication terminals are mobile (or cellular) telephones. However, the invention is not limited to this type of radio terminal. In fact it concerns any fixed or mobile (or portable or cellular) communication equipment capable of exchanging data by radio with another equipment via a radio access network. Consequently, it may equally be a question of fixed or mobile (or cellular) telephones, fixed or portable computers, or personal digital assistants (PDAs), equipped with radio communication means, where applicable of satellite type, adapted to receive broadcast data.

FIG. 1 is referred to first to describe the invention in the context of an application to a satellite network for broadcasting data, for example multimedia data. The network is of SDMB type, for example.

As shown in FIG. 1, a satellite broadcasting network may, very broadly speaking but nevertheless in sufficient detail for the invention to be understood, be summarized as comprising a core network CN coupled to a radio access network comprising in particular a radio communication gateway GW and at least one communication satellite SA.

The gateway GW comprises in the conventional way an equipment defining a base station N including in particular a sender module ME and a receiver module MR.

The sender module ME receives the data to be transmitted to the terminals UE and integrates it into data frames intended to be transmitted to the satellite SA in the form of radio signals on a go channel primarily dedicated to broadcasting data via the gateway GW (arrow F1), the satellite SA being thereafter responsible for broadcasting these data frames to the terminals UE (arrows F2). According to the invention, the sender module ME is also responsible for generating control messages comprising parameters intended to indicate to the terminals UE how they can access the return channel. These control messages are intended to be transmitted to the satellite SA in the form of radio signals in common control channels on the go channel (broadcast channel) via the gateway GW (arrow F1), the satellite SA being thereafter responsible for broadcasting them to the terminals UE (arrow F2).

The receiver module MR is responsible for receiving the data frames transmitted by the terminals UE on a return channel via the satellite SA and communicating them to the core network CN.

The go and return channels correspond to respective separate first and second frequency bands or to different time slots or sets of time slots (for example in the case of the TDD transmission mode).

At least some of the terminals UE are equipped with a processor device D coupled to or integrated into their communication module MC (as shown in FIG. 1 by way of example).

The processor module D comprises a processor module MT responsible firstly for analyzing the contents of control messages generated by the sender module ME of the gateway GW and broadcast by the satellite SA on the go channel, in order to extract the parameters for accessing the return channel that some of them contain.

When the processor module MT has these return channel access parameters, it is then in a position, each time that its terminal UE requires it, to generate data messages intended to be transmitted to the network by the communication module MC of said terminal UE on the return channel and via the satellite SA.

The originality of these data messages resides in the fact that they do not necessitate systematic acknowledgement from the network on the go channel. More precisely, this type of data message is not the subject of any kind of acknowledgement by the network, unless this is expressly required by auxiliary data (representing an acknowledgement request by the network on the go channel). Consequently, if a data message does not include auxiliary data representing an acknowledgement request, it is not acknowledged.

The processor module MT can therefore be made responsible for integrating such auxiliary data into some of the messages to be transmitted.

This integration may be effected at the request of the terminal UE or following the analysis of the data that the terminal UE wishes to transmit on the backward channel. In the second case, the processor module MT analyzes the data that must be transmitted in the form of a message in order to determine its priority level, for example. The processor module MT then determines whether that priority level justifies an acknowledgement request. For example, there may be high and low priority levels for which an acknowledgement must be requested and must not be requested, respectively. The high level may be reserved for data that indicates any type of emergency, for example, the message then constituting an emergency message.

In a first variant, the processor module MT may analyze the data that must be transmitted in the form of a message in order to determine if it is associated with a marker defining its type.

In a second variant, the processor module MT may determine via its terminal UE if the available capacities on the go channel enable the transmission of an acknowledgement on that same channel.

If the acknowledgement request is not justified, the processor module MT transmits the data message to the communication module MC of its terminal UE, without adding auxiliary data to it. On the other hand, if the acknowledgement request is justified, the processor module MT transmits the data message to the communication module MC of its terminal UE, after appending to it auxiliary data representing an acknowledgement request.

The transmission of data messages to the satellite SA may for example be effected by random access on the return channel. In a variant corresponding to a TDD type transmission mode, some time slots reserved for the return channel may be used to transmit the data messages. Assigning specific time slots of the return channel to different types of data message or as a function of what is required or of the absence of a requirement for acknowledgement may even be envisaged. Assigning specific frequencies of the bandwidth of the return channel to different types of data message or as a function of the requirement or the absence of requirement for acknowledgement may equally be envisaged

The data messages may take diverse forms. Thus it may be a question for example of short text messages (such as SMS (or “Short Message Service”) messages, for example), where appropriate adapted so as not to necessitate systematic acknowledgement on the go channel. The adaptation may be effected at the level of the short message header, for example. Not adapting the short message may equally be envisaged. In this case, the equipment N that is responsible for receiving the data message knows, if it is transmitted on the return channel, that there is no requirement to acknowledge it, unless this is requested. The terminal UE knows that it is not expecting an acknowledgement.

It may equally be a question of messages of the type that are used to transmit measurements to the network, for example measurement reports used in UMTS type networks in particular. Such reports are used for example to communicate position measurements determined by an internal application of the terminal UE from location information (for example from a constellation of GPS or GALILEO satellites) or measurements of volume of traffic or of quality of service (QoS) determined by an internal application of the terminal UE.

It may equally be a question of messages of the type that are used to signal to the network events internal to the terminal UE.

It may equally be a question of messages of the type that are used to transmit presence tokens to the network for effecting audience measurements.

Such messages generally contain at least a cause field for defining the cause for sending and a content field intended for the information to be transmitted.

For example, the processor module MT may place the data to be transmitted, as well as any auxiliary data, in the content field of a message of one of the types cited above. It is equally possible to integrate the data message to be transmitted (with any auxiliary data) in the content field of a message of the type cited above, which constitutes a kind of encapsulation.

It will be noted that the data to be transmitted replaces or complements, in the content field, the measurements that are effected by the terminal UE or the data that represents an event internal to the terminal UE or a presence token.

The size of the data messages, in terms of the number of bits, varies. It may be restricted to a maximum value. In this case, if the data to be transmitted exceeds the threshold value (number of bits), the processor module MT may be adapted to split it into at least two groups of data, in order to integrate those groups into different messages transmitted successively by the communication module MC of the terminal UE on the return channel.

Thus integrating the content of an electronic mail (or “e-mail”) in one or more data messages may be envisaged.

The data to be transmitted may equally represent a code of a few bits that for the network corresponds to a specific message.

Of course, it is possible to create a new type of message specifically dedicated to the transmission of data on the return channel.

It will be noted that the device D is not necessarily obliged to generate its messages if its terminal UE is placed in a mode authorizing it to receive the broadcast services.

Each data message generated by a processor device D is transmitted in the direction of the satellite SA by the communication module MC of the terminal UE on the return channel (arrow F3). The satellite SA then retransmits each data message that it receives on the return channel in the direction of the gateway GW, using that same return channel (arrow F4).

If the receiver module MR of the base station N installed in the gateway GW receives a data message from a terminal UE, it begins by analyzing its content in order to determine if it includes auxiliary data representing an acknowledgement on the go channel. If this is not the case the message is processed locally, or transmitted to the core network CN if there is no repeater (according to its content).

On the other hand, if an acknowledgement is required, the receiver module MR orders the associated sender module ME to generate an acknowledgement message to the terminal UE concerned. That acknowledgement message is then transmitted to the satellite SA on the go channel (arrow F1) and then broadcast by the satellite SA to the terminal UE concerned. At the same time, the received data message is processed locally or transmitted to the core network CN (according to its content).

If specific time slots of the return channel or specific frequencies of the bandwidth of the return channel are used to transmit data messages of different types or as a function of whether there is a requirement for or no requirement for an acknowledgement, the receiver module MR can deduce from the time slot or the frequency used to transmit the data message if an acknowledgement must be transmitted.

A mode of operation may equally be envisaged in which the receiver module MR requests the transmission of an acknowledgement only on condition that the capacities available on the go channel enable this. For example, if those capacities do not enable this, the transmission of the acknowledgement may be deferred.

If a terminal UE is obliged to transmit several (at least two) data messages to transmit in the form of groups an (initial) set of data the size whereof is greater than the maximum value, then the receiver module MR of the base station N begins by assembling the groups of data in an ordered manner in order to reconstitute the initial data set. It then proceeds as if this were a single message by analyzing its content to determine if it must be the subject of an acknowledgement, before transmitting the reconstituted data set to the core network CN or processing it locally.

FIG. 2 is referred to now to describe the invention in the context of an application to a terrestrial network for broadcasting data, for example multimedia data. The network is a cellular (or mobile) network of UMTS/DVB-H type, adapted for the broadcasting of mobile television (or “mobile TV”) programs, for example. However, it could equally be a UMTS/MBMS type network, for example.

As shown in FIG. 2, a UMTS network adapted for broadcasting may, very broadly speaking but nevertheless in sufficient detail for the invention to be understood, be regarded as a core network CN coupled to a radio access network (UTRAN).

The radio access network primarily includes interconnected base stations (Nodes B) Ni and radio network controllers (RNC) or nodes Rj to each other.

Each base station Ni is associated with at least one (logical) cell Ci covering a radio area (or coverage area) in which mobile (or cellular) radio communication terminals MS can set up (or continue) radio connections and in which this base station Ni can broadcast data, for example multimedia data (such as television programs in particular).

In the example shown, only three cells (C1-C3, i=1 to 3) have been represented. However, the index i may take any non-zero value. Moreover, in the example shown, each base station Ni is associated with a cell Ci. However, a base station may be associated with a plurality of cells.

Each radio network controller Rj is coupled to at least one base station Ni. In the example shown, only two radio network controllers (N1 and N2, j=1 and 2) have been represented. The controller R1 is coupled to the base stations N1 and N2, and the controller R2 is coupled to the base station N3. However, the index j may take any non-zero value.

The core network CN comprises network equipments some of which are connected in particular to the radio network controllers Rj. These equipments include in particular at least one serving GPRS support node (SGSN) connected in particular to radio network controllers Rj and at least one gateway GPRS support node (GGSN) connected to the SGSN node and connecting the core network CN to a services network (for example of IP type) materially representing the services made available to the users of the mobile terminals MS by the operator of the UMTS network, and in particular the data broadcasting services.

As in the preceding embodiment, the go and return channels of the terrestrial network correspond to respective separate first and second bands of frequencies or separate time slots or sets of time slots (for example in the case of TDD transmission mode).

This second embodiment is substantially identical to the first. It differs therefrom only in the radio access network used. The terminals UE include the same type of processor device D as that described above with reference to FIG. 1. Each base station (Node B) Ni has a sender module ME and a receiver module MR of the types described hereinabove with reference to FIG. 1 (here they are adapted to terrestrial rather than satellite communications, of course).

Consequently, the sender module ME of a base station Ni receives the data to be broadcast to the terminals UE from the associated controller Rj (which itself receives this data from the core network CN) and integrates it into data frames that it broadcasts in its coverage area in the form of radio signals on the go channel. Some of the broadcast data constitutes control messages comprising the return channel access parameters.

For its part, the receiver module MR is responsible for receiving in particular data messages transmitted on the return channel by the terminals UE that are situated in the coverage area of its base station Ni and then for analyzing their contents (where appropriate after reconstituting them) in order to determine if they must be the subject of an acknowledgement, and finally for processing these contents locally or communicating them to the core network CN via the associated controller Rj.

Each processor device D according to the invention, and in particular the processor module MT that it comprises, may be produced in the form of electronic circuits, software (or electronic data processing) modules, or a combination of circuits and software.

In the two examples described hereinabove the radio access network of the broadcast network is either purely a satellite network or purely a terrestrial network. However, the invention applies equally to hybrid networks including a satellite radio access network and a terrestrial radio access network, at least one of which is adapted to broadcast data. Thus a broadcast go channel that is a purely satellite channel (for example of DVB-H type adapted to satellite broadcasting) and a return channel that is a purely terrestrial channel (for example of UMTS type) may be envisaged.

Moreover, the network equipments that are made responsible for analyzing the contents of the data messages are not necessarily base stations (or their functional equivalent). They may equally well be terrestrial repeaters (preferably operating bidirectionally) of a hybrid network.

The invention is not limited to the processor device, radio communication terminal and radio communication network embodiments described hereinabove by way of example only, and encompasses all variants that the man skilled in the art might envisage within the scope of the following claims.

1. Processor device (D) for a radio communication terminal (UE) adapted to be connected to a radio communication network having a go channel for broadcasting data from said network to terminals (UE) and a return channel dedicated to transmitting data from the terminals (UE) to said network, characterized in that it comprises processor means (MT) adapted to extract from control messages broadcast by said network on the go channel parameters for access to said return channel and to generate data messages to be transmitted to said network on said return channel as a function of said access parameters and not necessitating systematic acknowledgement on said go channel.

2. Device according to claim 1, characterized in that said processor means (MT) are adapted to integrate into some of said messages auxiliary data representing a request for acknowledgement by said network on its go channel.

3. Device according to claim 2, characterized in that said processor means (MT) are adapted to analyze the data to be transmitted in the form of a message to determine its priority level and to decide to integrate said auxiliary data into a message containing the analyzed data as a function of its priority level.

4. Device according to claim 1, characterized in that said processor means (MT) are adapted to split data to be transmitted into at least two data groups and to integrate said groups into different messages.

5. Device according to claim 1, characterized in that said data messages to be transmitted are short type messages adapted not to necessitate systematic acknowledgement on said go channel.

6. Device according to claim 1, characterized in that said data messages to be transmitted are measurement report type messages comprising said data to be transmitted.

7. Device according to claim 1, characterized in that said data messages to be transmitted are internal event report type messages comprising said data to be transmitted.

8. Device according to claim 6, characterized in that said data to be transmitted replaces the measurements effected by said terminal (UE) or data representing an event that has occurred in said terminal (UE).

9. Device according to claim 6, characterized in that said data to be transmitted is added to the measurements effected by said terminal (UE) or data representing an event that has occurred in said terminal (UE).

10. Device according to claim 6, characterized in that said processor means (MT) are adapted to integrate said data to be transmitted into a content field of a measurement or internal event report message.

11. Device according to claim 1, characterized in that said processor means (MT) are adapted to order the transmission of said data messages at frequencies that are a function of their type and/or the requirement for acknowledgement.

12. Device according to claim 1, characterized in that said processor means (MT) are adapted to order the transmission of said data messages in time slots that are a function of their type and/or the requirement for acknowledgement.

13. Radio communication terminal (UE) adapted to be connected to a radio communication network having a go channel for broadcasting data from said network to terminals (UE) and a return channel dedicated to transmitting data from the terminals (UE) to said network, characterized in that it includes a processor device (D) according to claim 1.

14. Radio communication network comprising first communication means (ME, SA) adapted to broadcast data by radio on a go channel and second communication means (MR, SA) adapted to receive data transmitted by radio communication terminals (UE) by radio on a return channel, characterized in that said first communication means (ME, SA) are adapted to generate and to broadcast on said go channel control messages to said terminals (UE) including parameters defining access to said return channel and said second communication means (MR, SA) are adapted, in the case of reception on said return channel of messages generated by said terminals (UE) by means of a processor device (D), to analyze each message to determine if it requires an acknowledgement on said go channel and to order said first communication means (ME, SA) to generate an acknowledgement message to the terminal (UE) concerned if such acknowledgement is required.

15. Network according to claim 14, characterized in that said second communication means (MR, SA) are adapted, in the case of reception on said return channel of messages including data groups resulting from splitting of initial data by a processor device (D) of a terminal (UE), to re-assemble said groups in an ordered manner to reconstitute said initial data.

16. Network according to claim 14, characterized in that said second communication means (MR, SA) are adapted to analyze the content of each message to determine if it requires an acknowledgement.

17. Network according to claim 14, characterized in that said second communication means (MR, SA) are adapted to determine if a message requires an acknowledgement as a function of the time slot in which it was transmitted.

18. Network according to claim 14, characterized in that said second communication means (MR, SA) are adapted to determine if a message requires an acknowledgement as a function of the frequency on which it was transmitted.

19. Network according to claim 14, characterized in that said second communication means (MR, SA) are adapted to order the transmission of an acknowledgement if the available capacities on the go channel enable such transmission.

20. Network according to claim 14, characterized in that said second communication means (MR, SA) are adapted to order the deferred transmission of an acknowledgement if the available capacities on the go channel do not enable such transmission.

21. Network according to claim 14 characterized in that said first communication means (ME, SA) and said second communication means (MR, SA) are at least in part installed in base stations (Ni; N) adapted to analyze the content of each message generated by a terminal (UE) by means of a processor device (D).

22. Network according to claim 14, characterized in that said first communication means (ME, SA) and said second communication means (MR, SA) are at least partially installed in terrestrial repeaters adapted to analyze the content of each message generated by a terminal (UE) by means of a processor device (D).
